(19) United States
(12) Patent Application Publication
(10) Pub. No.: US 2007/0193191 A1
(43) Pub. Date: Aug. 23, 2007

(54) Joinery panel accessory system

(75) Inventor: Michael John Hancock, Hamilton (NZ)

Correspondence Address: BROOKS KUSHMAN P.C., 1000 TOWN CENTER, TWENTY-SECOND FLOOR, SOUTHFIELD, MI, 48075, US

(73) Assignee: HPJ HOLDINGS LIMITED, Hamilton (NZ)

(21) Appl. No.: 10/598,748

(22) PCT Filed: Mar. 10, 2005
(86) PCT No.: PCT/NZ05/00044

§ 371 Date: Sep. 11, 2006

(30) Foreign Application Priority Data
Mar. 11, 2004 (NZ) 531714

(51) Int. Cl. E06B 1/04

(52) U.S. Cl. 52/698; 52/204.1

(57) ABSTRACT

Panel accessory system for a movable panel (3) of a joinery system (2) including a locking system (1) incorporating a catch (9) associated with the leading edge (4a) of the panel to be secured, a locking member (6) associated with a panel receiving face (5) whereby the locking member engages the catch.

### TECHNICAL FIELD

The present invention relates to a joinery panel accessory system. In particular, reference throughout the specification will be made to sliding panels being secured and also opened and closed through use of the present invention. However, those skilled in the art should appreciate that other types of panels, and different types of joinery systems may also employ the present invention if required.

### BACKGROUND ART

Joinery is used to frame and mount glazing in the windows and entrance ways of buildings.

Traditionally wooden joinery has been employed for such purposes. Wooden joinery functions effectively to provide both an aesthetically attractive interior for a window or doorway and also performs well as a thermal insulator.

However, wooden joinery is not directly suited to mass production techniques and applications. Wood generally requires a high level of skill from a manufacturing labourer to form the required joinery shapes and also to install the resulting joinery in a building. Furthermore, the wood used, although relatively attractive in its final finished form, is also a relatively costly building material.

Aluminium joinery has been developed as an alternative to wooden joinery. Aluminium can be extruded into relatively complex profiles (or forms) in large volumes with relatively low labour costs.

Furthermore, the cost of the aluminium material is lower than that of wood, thereby resulting in a comparatively low cost joinery product.

Sliding panel joinery can provide a window or doorway through a movable or sliding panel. This type of joinery normally employs a fixed static panel and a sliding panel adjacent to the fixed panel.

The sliding panel can be moved laterally across a track laid in the joinery to open and close a window or doorway formed in a structure.

Sliding panel joinery can be configured so that the sliding panel, when placed in an open configuration, covers the exterior surface of the fixed panel (an exterior slider), or can alternatively cover the interior surface of the fixed panel (an interior slider).

Sliding panel joinery doors also need to be secured against unauthorized persons opening the panel, and in some instances can require the addition of further components or hardware to assist a user in opening or closing the panel.

In common forms of sliding door joinery, a latch and/or handle pull system is normally mounted to the interior side of the sliding panels' leading style. However, this type of design can result in a relatively large, and obvious projecting component extending from the leading style, resulting in a potentially unattractive design. This problem is also aggravated in instances where a relatively heavy latch or locking component used to improve the security of the sliding door when locked closed.

In some instances, the design of the leading style may be such that there is minimal or no surface of the panels′ leading style exposed when closed. In such situations, conventional handles, latches or locks mounted directly to the leading style cannot be used.

With these types of hidden joinery panels, it is also difficult for an observer or user to identify whether a panel actually slides or moves, and also how to open the panel without placing their hands directly on the main body or glazed surface of the panel. It would be preferable in such cases to have a handle mechanism which did not necessarily need to be mounted directly to a panels' leading style, and which was visible on a closed panel to indicate that the panel can be slid open.

An improved joinery locking system or systems which addressed any or all of the above problems would be of advantage. In particular, a locking system which provided a handle, latch and/or locking mechanism which need not be directly mounted to the leading style of a sliding panel door or window would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a panel accessory system for a moveable panel of a joinery system, the accessory system including a panel locking system which includes,

a catch associated with the leading edge of a panel to be secured, and

a locking member associated with the panel receiving face of the joinery system,

wherein the locking member is engaged by the catch to secure the moveable panel.

According to a further aspect of the present invention, there is provided a panel locking system substantially as described above wherein the locking member is adapted to move along an axis perpendicular to the panel.

According to yet another aspect of the present invention there is provided a panel locking system substantially as described above wherein the moveable panel is formed by a sliding panel and the catch is located within the leading edge of the leading style of said sliding panel,

wherein the panel receiving face of the joinery system is formed by a jamb of said joinery system.

According to yet another aspect of the present invention there is provided a panel locking system substantially as described above wherein the locking member is formed by a bolt orientated substantially perpendicular to a moveable panel to be secured.

According to yet another aspect of the present invention there is provided a panel locking system substantially as described above wherein the catch is formed by a staple element adapted to provide an enclosed locking aperture.

According to an alternative aspect of the present invention there is provided a panel locking system substantially as described above wherein the locking member is formed by a pivoting member.

According to yet another alternative aspect of the present invention these is provided a panel locking system substantially as described above wherein the catch is formed by a housing which includes a recess, said recess having a complementary shape to that of the pivoting locking member.

According to yet another aspect of the present invention there is provided a panel accessory system for a movable panel, said movable panel including a leading frame portion and a trailing frame portion which are adapted to at least in part frame one or more central sheets of material to form said panel,

the panel accessory system including a panel sheet accessory which includes

a main body portion which is adapted to at least in part fit between at least one central sheet and the leading frame portion of a movable panel.

According to yet another aspect of the present invention there is provided a panel sheet accessory substantially as described above wherein a portion of the main body is adapted to extend over at least a portion of the end of a central sheet received by the leading frame portion and a side face of said central sheet.

The present invention may provide a panel locking system. This system may be used to preferably secure and also lock a panel of a joinery system closed. Such panels may be moveable between open, closed and partly open configurations to provide doorway or window openings when required.

However, in some instances, the accessory system provided may be adapted to implement a mechanism which need not necessarily lock a moveable panel in a closed position, nor require key or any other authorizing token to lock or unlock same.

Furthermore, the panel accessory system provided may also be adapted to implement a handle or pull component which can be employed by a user to move a panel between open and closed and partially open configurations. Such a handle or pull component need not necessarily latch, lock or secure the panel but may function simply to assist in the movement of a panel.

Reference throughout this specification will be made to the present invention providing a panel accessory system which may be used to implement any combination or permutation of panel locking, latching or the handle functionalities discussed above. Those skilled in the art should appreciate that a range of various accessories may be considered to be within the scope of the accessory system provided in accordance with the present invention.

Reference throughout this specification will also be made to the joinery system which employs the present invention being formed from aluminium and also providing a sliding panel door assembly. However, those skilled in the art should appreciate that the accessory system discussed need not necessary be implemented using sliding panels nor aluminium joinery in isolation only.

Furthermore, reference throughout this specification will also be made to the panel in question incorporating a leading frame portion (formed by the leading style in a sliding panel), and a trailing frame portion (formed by the trailing style in a sliding panel), which assist in framing one or more central sheets of material to make up the panel involved.

Preferably the sliding panel with which the accessory system is to be used may include at least one glass or glazing sheet to provide a sliding window or doorway. In a further preferred embodiment a pair of spaced glazing sheets may be employed as the central sheets of a sliding panel framed to implement a double glazed panel.

However in an alternative embodiment multiple sheets formed in panes may be employed within a panel. Those skilled in the art should appreciate that reference to the provision of a single central sheet of material throughout this specification should in no way be seen as limiting.

Reference throughout this specification will also be made to the panel with which the accessory system is employed being a double glazed sliding panel where spacer elements are spaced between each of the glazing sheets. However, those skilled in the art should appreciate that other types of framed sheet material may be used in the formation of the panel and reference to the above only throughout this specification should in no way be seen as limiting.

The locking system provided may include or incorporate a catch associated with the leading edge of a panel to be secured. This catch can be adapted to engage with or connect to a locking member to secure a sliding panel. Preferably this locking member can be integrated with or located within the receiving face of the joinery system which locates the moveable panel. This receiving face of the joinery system will therefore have the leading edge of the panel moved towards it to close the door or window opening provided.

In a further preferred embodiment, where the present invention is used to secure a sliding panel the leading edge of the panel may be integrated within the leading style of the panel framing. The leading edge of the leading style will therefore be moved horizontally towards a receiving face of an opposed jamb to close the sliding panel door.

In a preferred embodiment the locking member associated with the door jamb may be formed from or incorporate a bolt element orientated substantially perpendicular to the main face of the sliding panel to be secured. The perpendicular orientation of such a bolt element will place the locking components of the locking system within an enclosed covered area of the receiving door jamb when the sliding panel is closed. Furthermore, when a force is applied to the exterior of the locked door to force same open, this force will act perpendicular to the orientation of the bolt thereby substantially increasing the strength and security of the locking system employed.

In an alternative embodiment the locking member associated with the door jamb may be formed from or incorporate a pivoting locking member element. In such embodiments, this pivoting member may be formed from a semi-circular element, with one end of this element being pivotably connected to a jamb. Such an element may then be pivoted into engagement with a catch to secure a sliding panel.

In a preferred embodiment the catch may be formed by or from a substantially staple like element which projects out from the leading edge or face of the leading style. This staple element may form or define an enclosed locking aperture which extends out from the front of the leading style and through which the locking member or locking bolt may be moved and secured.

However, in an alternative embodiment the catch maybe formed by or from a housing which includes a recess, with this recess having a complementary shape to that of the pivoting locking member discussed above.

Referenced throughout the specification will now be made to a locking member being formed by a bolt and the catch being formed by a staple. However, those skilled in the art should appreciate that other types of locking systems may be used, and reference the above throughout this specification should in no way be seen as limiting.

The provision of such a staple element in combination with a locking bolt member provides a substantial improvement to the security of the sliding panel when closed and locked. Tampering forces must be applied perpendicular to the orientation of the bolt thereby requiring substantially the entire bolt to be deformed prior to the failure of the locking system. This can provide significant improvements for sliding panels or door locks which normally rely on a pivoting latch or hook arrangement located on the panels' leading style which engages with a cavity or recess in a door jamb. A relatively small deviation in the pivoting hook needs to be achieved to result in the failure of such locks—as opposed the significant forces required to effectively break a locking bolt provided in conjunction with the present invention.

In a preferred embodiment the bolt or locking member provided within the locking system may be linked to a drive mechanism and also preferably a user actuation system. A user actuation system may provide a mechanism such as a knob, lever or button arrangement which links to the drive mechanism to move the locking bolt from locked to unlocked and from unlocked to locked positions. For example, in one further preferred embodiment a user actuation system may be implemented through a rotatable knob which engages with a ratchet based drive mechanism directly linked to a locking bolt member. Rotation of the knob by a user will then drive the movement of the locking bolt member.

In one alternative embodiment a user actuation system may be linked to an alternative form of lock to the bolt based system discussed above. For example, in some alternative embodiments a rotatable knob forming such a user actuation system may be used to rotate a pivoting locking member into engagement with a complementary recess forming a catch in the leading style of a panel frame.

In a preferred embodiment a user actuation system may be enabled or disabled with the use of a key or other appropriate form of authorization token. Those skilled in the art should appreciate that well known technology may be used to implement a key and lock barrel used to enable or disable the operation of a user actuation system or the locking system discussed above. For example, in some instances, a key may be used on the interior side of a closed panel to disable the operation of user actuation system or component mounted on the exterior side of the same panel if required.

As discussed above, a panel accessory system provided in accordance with the present invention may also include a panel sheet accessory.

In a preferred embodiment a panel sheet accessory provided in conjunction with the present invention may include a main body. This main body may form the bulk of the material or volume of the sheet accessory and may act as a base, frame or mounting for other functional components of the sheet accessory.

In a preferred embodiment a portion of a sheet accessory's main body may be inserted or installed between at least one of the central sheets of a panel and the leading frame portion (preferably the leading style) of the panel involved. The installation of a portion of such a main body between these two components essentially inserts the main body into the interior of the leading frame portion or leading style. This will in turn provide the leading frame portion with an increased range of travel as the panel sheet accessory provided need not necessarily extend out past the side or width of the leading style to catch against a jamb or mullion of the joinery involved.

In a further preferred embodiment a portion of a panel sheet accessory's main body may extend out over at least a portion of the end of a glazing sheet and to also extend out over a section of the side or face of such a sheet parallel to and in contact with the sheet involved. This installation arrangement sandwiches a projecting leg of the main body between the end of at least one glazing sheet and the internal end face of the leading style—in addition to sandwiching a portion of a main body between a side wall of the leading style and face of glazing sheet on one side of the panel. This will in turn allow loads or forces to be applied to the opposite end or other components of the main body without necessarily dislodging same from its mounting within the leading style.

In one preferred embodiment the free or extending end of the main body opposite to the leading style may be adapted to form or implement a handle arrangement with the associated panel. Preferably the free end of the main body may extend parallel to the face of a panel in such instances to maximise the distance which the panel can travel without hitting the sides of the joinery jamb in which it is mounted. A handle component may then be formed in the free end of the main body which can be grasped by user and pushed or pulled to in turn promote movement of the panel.

In a further preferred embodiment a handle formed by a panel sheet accessory may be implemented as a finger pull component. Such a finger pull handle may be formed simply by a scallop, recess or indentation in the surface of the main body at its free end. This indentation will then provide a bearing or contact surface which a user can push against to open to move the panel.

In an alternative and also potentially preferred embodiment a panel sheet accessory may form or implement a latch system for a panel. Such a latch may engage with a catch formed in a recess in the panel joinery jamb which receives the leading style of a sliding panel. In such instances the free end of the sheet accessory's main body may include a pivoting or movable head or latch element which can be moved into the jamb's catch recess to subsequently latch closed the panel. This latch element may lie flush or in line with the surface of the cladding. Conversely, this latch element may then be pivoted, slid or otherwise moved out of engagement with the jamb catch recess to release the latch provided.

In a further embodiment a panel sheet accessory may also implement both the handle and latch functionalities discussed above. A free end of the main body may diverge to two separate ends or components which implement both a handle and also a latch for a panel.

A joinery panel accessory system substantially as described above may provide many potential advantages over existing prior art accessories and accessory systems.

The provision of a locking system which employs a bolt associated with the panel jamb results in a ‘captivated’ dead bolt facility. This promotes security in the resulting locking system by substantially increasing the forces required to force entry when compared with existing prior art locking systems.

A handle (or preferably finger pull) panel sheet accessory may also be provided to maximise the distance which a panel may travel prior to any components blocking against the jamb of the surrounding joinery. A comparatively small finger pull element may promote the aesthetic appeal of the resulting panel and associated joinery, and may also allow the handle components provided to slide past a central mullion of the joinery if required. This type of handle can also provide a visual indication that the panel involved is able to move.

A similar approach may also be taken with the implementation of a latch associated with a panel sheet, which again can be adapted to limit any interference between the leading style and the jamb which receives it. A compact and minimalist latch design may be implemented to catch into a recess provided in a jamb to hold a panel closed or in place when required.

### BRIEF DESCRIPTION OF DRAWINGS

Further aspects of the present invention will become apparent from the following description which is given by way of example only and with reference to the accompanying drawings in which:

FIGS. 1a, 1b FIG. 1a shows a top cross section view of a locking system accessory installed in a sliding panel joinery system, and FIG. 1b shows a side view of a leading style, including a catch and bolt, and

FIG. 2 shows a top cross section view of an alternative panel sheet locking accessory installed in the panel receiving face of a sliding panel joinery system, and

FIGS. 3a, 3b show side cross section views of the alternative locking system accessory which may be installed in a sliding panel joinery system in accordance with the embodiment shown in FIG. 2, and

FIGS. 4a, 4bFIG. 4ashows a top cross section view of a panel sheet handle accessory installed in a sliding panel joinery system in accordance with an alternative embodiment, and FIG. 4bshows a perspective view of a panel sheet accessory, and

FIG. 5 shows a top cross section view of a panel sheet latch accessory installed in the panel receiving face of a sliding panel joinery system in accordance with a further alternative embodiment of the present invention.

### BEST MODES FOR CARRYING OUT THE INVENTION

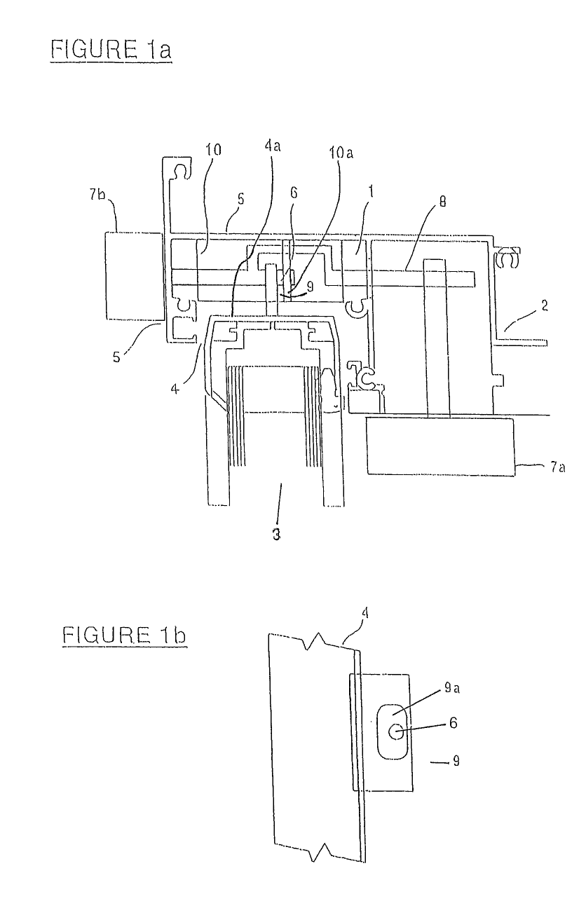

FIG. 1a shows a top cross section view of a locking system accessory installed in the panel receiving face of a sliding panel joinery system in accordance with one embodiment of the present invention.

A locking system (1) is provided in conjunction with both a joinery system or assembly (2) and also a movable panel, shown as a sliding panel (3).

The end of the sliding panel (3) is framed by a leading style (4), the end of which defines a leading edge (4a) for the panel.

The panel (3) shown in FIG. 1 is located in a closed position where the panel's leading style (4) is received by the panel receiving face of the joinery system, implemented in this embodiment by the jamb sections (5) of the joinery (2).

The locking system (1) is implemented through a locking member formed in this embodiment by a locking bolt (6) linked to a pair of user actuation elements (7a, 7b) via a drive shaft mechanism (8). This locking member is adapted to move along an axis perpendicular to the panel.

The locking system (1) also incorporates a catch (9) mounted on the front surface (4a) of the panel's leading style (4). Preferably this catch is implemented through a staple shaped element which defines an enclosed locking aperture through which the free end of the bolt (6) may be moved. FIG. 1 shows the locking system in a locked configuration where the free end of the bolt (6) has been moved through the catch (9) on the leading style of the panel (3).

The locking mechanism also includes a locating box form (10) which assists in locating the drive shaft (8) of the actuation assemblies and also the free end of the bolt (6). This locking box provides an additional plate (10a) within its interior with an aperture through which the end of the locking bolt can be inserted. This locking plate (10a) acts to also lock the bolt (6) to the interior surface of the receiving jamb (5).

FIG. 1b shows a side cross section view of the leading style (4) of the sliding panel discussed with respect to FIG. 1a. As can be seen from FIG. 1b, the catch (9) shown defines or forms an enclosed locking aperture (9a) through which the end of the bolt (6) is to be slid or moved. This catch will then lock the sliding panel in place.

Each of the user actuation systems (7a, 7b) are formed by a rounded knob or projection which can be moved by a user to lock or unlock the system (1) provided. In the case of the first actuation system (7a) the knob shown may be turned to drive a ratchet system associated with the shaft drive mechanism (8) to in turn drive or push the bolt out of the catch (9). Conversely the second actuation system knob (7b) can be pulled outwards directly to unlock the bolt (6) from the catch (9) or in turn pushed inwards to drive the bolt (6) into the catch (9).

As can be seen from FIG. 1, any tampering force applied to break through the locking system (1) will be applied from the exterior side of the panel (3), being the side on which the second actuation system (7b) is located. A force applied to push the panel (3) open would therefore act at a right angle to the main body and length of the bolt (6) and also the majority of the drive mechanism (8). This characteristic of the locking system requires a relatively high magnitude force to be applied prior to the bolt and its associated components failing and allowing the panel to be open.

FIG. 2 shows cross sectional views of a locking system to be used in accordance with one alternative embodiment to that discussed above when installed into a sliding panel joinery system.

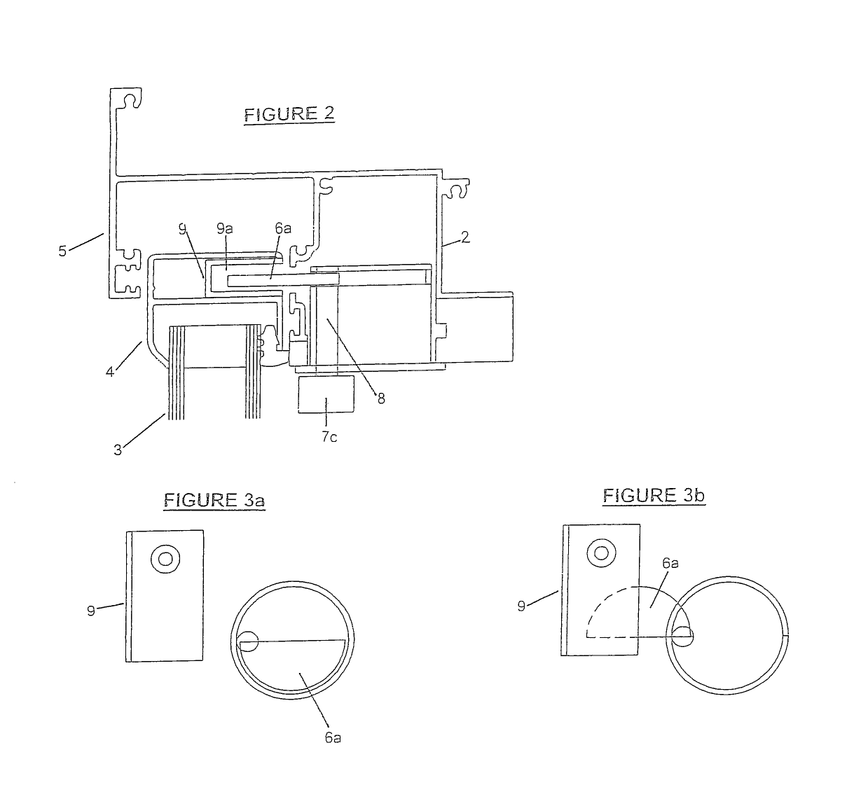

FIG. 2 shows the panel located in a closed position where the panels leading style (4) is received by the panel receiving face of the joinery system. The locking system is implemented through the locking member (6a) as shown in FIGS. 3a, 3bdiscussed below, linked to an alternative user actuation system. The locking system also incorporates a catch (9) mounted on the front surface of the panels leading style. Preferably, this catch is implemented by a recess (9a) which has a complementary shape to the pivoting locking member (6a).

The user actuation system (7c), used in conjunction with the alternative locking system discussed above, is formed by a knob or projection which can be moved by a user to lock or unlock the system provided. The knob shown may be turned to activate the drive shaft mechanism (8), this in turn pivots the locking member (6a) into a locked or unlocked position.

FIGS. 3aand 3bshow a side cross section views of a locking member to be used in accordance with the alternative embodiment discussed in FIG. 2.

FIG. 3ashows the provision of a pivoting locking member (6a) in an unlocked position in relation to a catch (9), and FIG. 3bshows the locking member (6a) in a locked position. As can be seen from FIG. 3a, the pivoting member in an unlocked position does not impede the motion of the panel. FIG. 3bshows the locking member will engage with a complimentary recess of a catch (9) integrated into the panel's leading style (4).

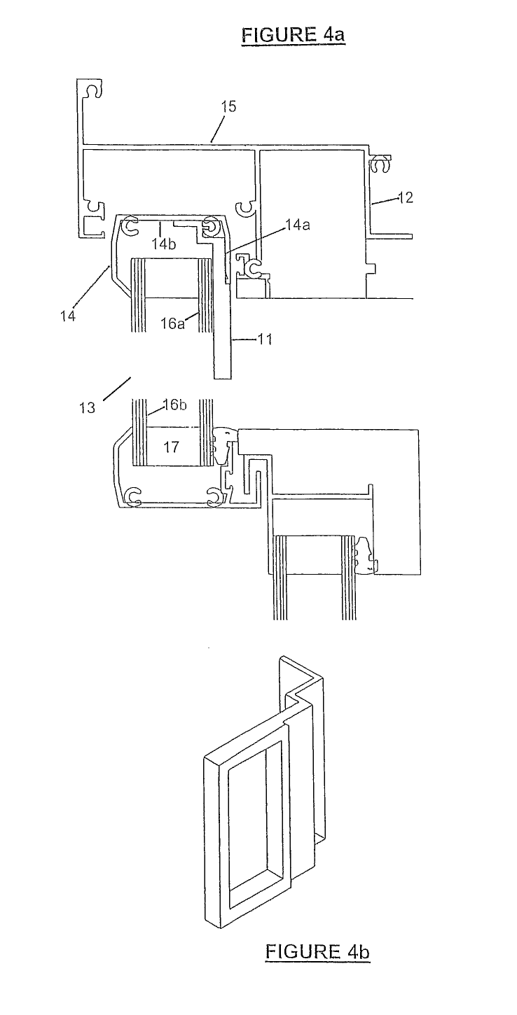

FIG. 4 shows a top cross section view of a panel sheet handle accessory installed in a sliding panel joinery system in accordance with an alternative embodiment of the present invention.

The panel handle (11) is installed within a sliding panel (13) of the joinery system (12). The panel (13) is shown in FIG. 4 in the closed position where the leading style (14) of the panel is engaged with and received by a jamb (15) of the joinery (12).

The bulk of the panel (13) is formed by a pair of glass or glazing sheets (16a, 16b) displaced or separated from one another by a pair of glazing spacer elements (17).

The panel accessory handle (11) is formed from a single component which defines a main body for the handle. The free end of the main body extends across the face of the glazing sheet (16a) whereas the opposite end of the main body is engaged within the interior of the leading style (14).

As can be seen from FIG. 4b, the free or extending end of the handle's main body forms a recess or aperture into which the user may insert the tips of one or more fingers to push against the handle component. This type of component can clearly be seen on the face of the glazing sheet (16a) when the handle is closed to indicate that the panel can be moved.

As can be seen from FIG. 4, this end of the main body fits between the end of the glazing sheet (16a) and the interior surface (14a, 14b) of the leading style. In the embodiment of the invention shown, this end of the main body is disposed across the entire width of the end of glazing sheet (16a) and also extends partway across the face of one of the glazing spaces (17) while being sandwiched against the interior face (14b) of the leading style (14).

The free end of the main body of the handle (11 ) also extends out across the face of glazing panel (16a) but does not protrude past the width of the leading style (14). This increases the distance which the panel may travel into the receiving jamb (15) without any components of the handle accessory (11) hitting the edges of the jamb (15) or other associated components of the joinery (12).

This configuration of the handle accessory (11) also allows the panel to slide backwards into an open position and for the handle to travel past a central mullion of the joinery without hitting the mullion. In effect this allows the fixed panel to again cover or hide the frame of a sliding panel when the sliding panel is moved into an open position. This increased freedom of movement will also in turn allow the majority of the framing components of the panel (such as the leading style (14)) to be covered by other cladding components of the joinery system (12), leaving only the handle accessory (11) visible to a user on an interior side of the joinery system. Such a user may immediately observe the presence of the handle accessory (11), indicating that the associated panel can be moved.

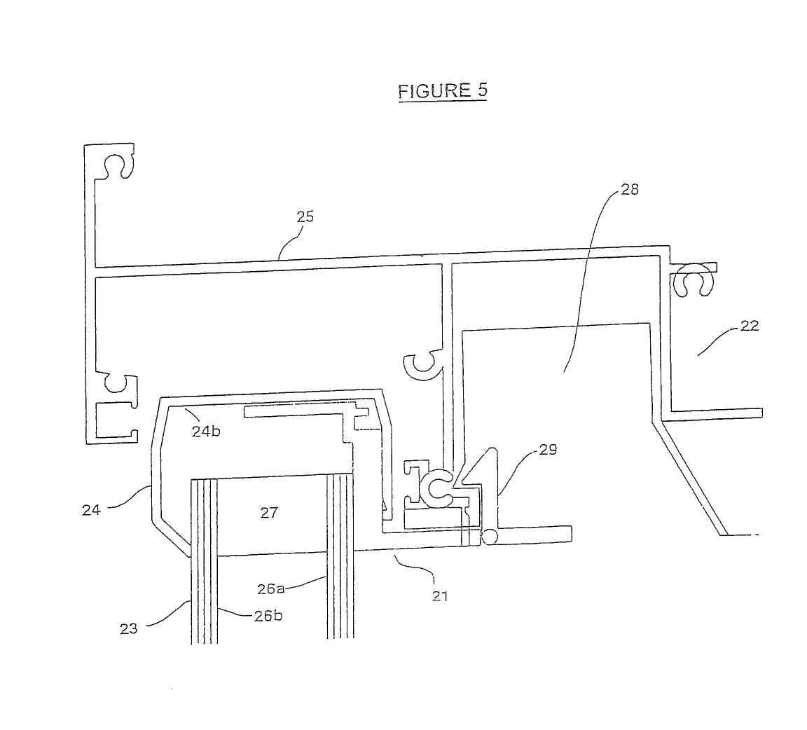

FIG. 5 shows a top cross section view of a panel sheet latch accessory installed in a sliding panel joinery system in accordance with a further alternative embodiment of the present invention.

In the embodiment shown, the panel sheet accessory (21) implemented provides a latch component for a sliding panel (23). In many respects the latch accessory (21) is similar in its installation and relationship to the joinery system (22) to the panel sheet handle accessory (11) discussed with respect to FIG. 4. One end of the main body of the latch accessory (21 ) is again inserted into the interior of the leading style (24) of the sliding panel (23) with this end of the latch accessory projecting over the end of a glazing sheet (26a) and at least partly across the face or side of the same sheet (26a).

However, the latch accessory (21) differs from the handle accessory (11) of FIG. 4 through the provision of a pivoting latch assembly (29) at the free end of the main body of the accessory (21). This pivoting latch can move into a recess formed by the section of the joinery assembly (22) to engage with a catch recess (28) formed in same. As can be seen from FIG. 5, the latch component (29) is engaged with the catch recess (28) of the joinery (22) to latch the panel (23) closed. The latch component (29) is aligned with the surface of the cladding. Conversely, the panel (23) may be unlatched through pivoting the latch component (29) away from the catch recess (28) which will subsequently allow the panel (23) to be slid open away from the receiving jamb (25) of the joinery (22).

Aspects of the present invention have been described by way of example only and it should be appreciated that modifications and additions may be made thereto without departing from the scope thereof.

1. A panel accessory system for a movable panel of a joinery system, the accessory system including
a panel locking system which includes,
a locking member associated with a panel receiving face of the joinery system, and
a catch associated with a leading edge of a panel to be secured,
wherein the locking member is received within a recess formed within the catch to secure the movable panel,
wherein the locking member is adapted to move along an axis perpendicular to the panel.

2. A panel accessory system as claimed in claim 1 wherein said movable panel includes a frame which is adapted to at least in part frame one or more sheets of material.

3. A panel accessory system as claimed in claim 2 wherein the movable panel is formed by a sliding panel.

4. A panel accessory system as claimed in claim 3 wherein the movable panel includes a leading frame portion and a trailing frame portion.

5. A panel accessory system as claimed in claim 4 wherein said at least one sheet of material is formed from glass.

6. A panel accessory system as claimed in claim 4 wherein the frame locates two sheets of glass to form a double glazed panel.

7. A panel accessory system as claimed in claim 4 wherein the catch is located on the leading edge of the leading frame portion of said sliding panel.

8. A panel accessory system as claimed in claim 1 wherein the locking member is orientated substantially perpendicular to the main face of the panel.

9. A panel accessory system as claimed in claim 8 wherein the locking member is a bolt.

10. A panel accessory system as claimed in claim 4 wherein the catch is formed from a staple element which projects out from the leading edge of the leading frame portion.

11. A panel accessory system as claimed in claim 1 wherein the locking member is formed by a pivoting member.

12. A panel accessory system as claimed in claim 11 wherein the catch is formed by a housing which includes a recess, said recess having a complimentary shape to that of the pivoting locking member.

13. A panel accessory system as claimed in claim 1 wherein the locking system is linked to a drive mechanism.

14. A panel accessory system as claimed in claim 13 wherein the drive mechanism is linked to a user actuation system.

15. A panel accessory system as claimed in claim 14 wherein the drive system is enabled or disabled by an authorization token.
